(19) United States
(12) Patent Application Publication
(10) Pub. No.: US 2025/0178119 A1
(43) Pub. Date: Jun. 5, 2025

(54) SYSTEMS AND METHODS FOR GENERATING GLASS-ENGRAVED NANOSCALE GRATING PERIODS FOR BIREFRINGEMENT METASURFACES

(71) Applicant: Lawrence Livermore National Security, LLC, Livermore, CA (US)

(72) Inventors: Nathan James RAY, Lathrop, CA (US); Hoang T. Nguyen, Livermore, CA (US); Eyal Feigenbaum, Livemore, CA (US); Jae Hyuck Yoo, Pleasanton, CA (US)

(21) Appl. No.: 18/524,951

(22) Filed: Nov. 30, 2023

(51) Int. Cl. B23K 15/08; B23K 15/00; B82Y 40/00

(52) U.S. Cl. CPC B23K 15/08; B23K 15/002; B82Y 40/00

(57) ABSTRACT

The present disclosure relates to a system for creating parallel, near-linear features with a desired period on a surface of a workpiece, where the workpiece includes a planar substrate and a material layer formed on the planar substrate. In one embodiment the system has an etching beam generator configured to generate a processing beam, and a support structure for holding a workpiece. The workpiece is held such that an upper surface of the material layer of the workpiece is supported at an angle which is non-normal to a direction of travel of the processing beam. The angle correlates to a desired period of features to be fabricated on the upper surface of the material layer. The processing beam transforms the material layer to create generally parallel, generally linear features having the desired a period. Subsequent normal incidence etching may be used to transfer this material layer grating mask structure to the underlying substrate.

### FEDERALLY SPONSORED RESEARCH OR DEVELOPMENT

This invention was made with Government support under Contract No. DE-AC52-07NA27344 awarded by the United States Department of Energy. The Government has certain rights in the invention.

### FIELD

The present disclosure relates to the manufacture of metasurfaces, and more particularly to systems and methods for the manufacture of components having an engraved nanoscale using an etching beam. The components may be birefringent metasurfaces and other similar structures.

### BACKGROUND

The statements in this section merely provide background information related to the present disclosure and may not constitute prior art.

Laser systems often utilize waveplates to control the polarization of the light, and, when used in conjunction with other optical elements, they can also be used to control the transmitted laser power. However, conventional birefringent materials have some significant limitations. One such limitation is that optical materials exhibiting natural birefringence often have a low laser-induced damage threshold. This limitation places an upper limit on the laser power the system can safely use before (i.e., upstream of) the waveplate. Another significant limitation is that conventional materials which exhibit bulk birefringence, and particularly for shorter wavelengths, tend to be costly.

One prior-art technique of forming a birefringent metasurface involves Glancing Angle Deposition (GLAD) to form tilted rods on a surface of the optical element. While this technique can use more robust materials than those exhibiting bulk birefringence, a limitation of this technique (and other techniques based on this type of deposition) is that the deposited material, while having similar optical properties, typically has weaker laser damage durability due to defects that accumulate during the deposition process.

A prior-art approach which uses angled etching through isotropic metal nanoparticle masks addresses the durability and short-wavelengths limitations mentioned previously. However, the metasurface birefringence is linked to the depth of the metasurface, which can introduce limitations due to challenges associated with etching deep enough. Still further prior art approaches have demonstrated the ability to replenish metal etching masks for continued etching to obtain increased etching depths not possible from a single mask layer of metal material. However, even this approach has limitations associated with angled etching; namely, etching at an angle may introduce undercutting that prevents the desired etching depth to be met.

Other optical components that are used frequently are gratings, which enable the incident light to be resolved into the spectral components. These components are typically fabricated through either lithographic techniques or optical interference; for most lithographic fabrication processes, scaling the final product up to length scales used with high power lasers (optics of ˜meter length scales) becomes technologically challenging. Similarly, fabricating such large structures with a period as small as 10 nm is also technologically challenging. For optical interference processes, scaling up to large apertures is not as challenging, but fabrication of the small periods demonstrated here is not possible with lasers available today.

### SUMMARY

This section provides a general summary of the disclosure, and is not a comprehensive disclosure of its full scope or all of its features.

In one aspect the present disclosure relates to a system for creating parallel, linear features with a desired period on a surface of a workpiece, where the workpiece includes a planar substrate and a material layer formed on the planar substrate. The system may comprise a generator configured to generate a processing beam, and a support structure for holding a workpiece. An upper surface of the material layer of the workpiece is supported at an angle which is non-normal to a direction of travel of the processing beam, and the angle correlates to a desired period of features to fabricated on the upper surface of the material layer. The processing beam causes transformation of the material layer to create generally parallel, generally linear features having the desired a period.

In another aspect the present disclosure relates to a system for creating parallel, linear features with a desired nanoscale period on a surface of a workpiece, where the workpiece includes a planar substrate and a metal material layer formed on the planar substrate. The system may comprise a reactive ion beam etching (RIBE) generator configured to generate a reactive ion processing beam. The system may also comprise a support structure for holding a workpiece, wherein one of the workpiece or the RIBE generator is tilted at a predetermined angle of inclination relative to the other to be non-parallel to the other. The angle of inclination is selected to correlate to a desired period of generally repeating, generally parallel, line-like features formed into the upper surface of the metal material layer by the reactive ion processing beam from the RIBE generator.

In still another aspect the present disclosure relates to a method for forming parallel, linear features with a desired period on a surface of a workpiece, wherein the workpiece includes a substrate and a material layer on the substrate, the method comprising. The method includes supporting the workpiece at an angle non-parallel to a direction of travel of a processing beam to be used to etch the material layer. The method further includes using the processing beam to perform a processing operation to transform the material layer to produce a periodic metasurface from the material layer. The periodic metasurface has a plurality of generally parallel, relatively linear features produced from a remaining portion of the material layer left after the processing operation is completed. Furthermore, the angle is selected to produce a desired period for the periodic metasurface.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations, and are not intended to limit the scope of the present disclosure.

Corresponding reference numerals indicate corresponding parts throughout the several views of the drawings.

FIG. 1a is a plan top view of a component showing a metal surface coating on a substrate (with the substrate being hidden underneath the metal coating);

FIG. 1b is a side cross sectional view of the component of FIG. 1a taken in accordance with arrow 1b in FIG. 1a);

FIG. 2a is a top plan view showing the generally parallel arranged, raised, metal containing beams formed on the substrate from the metal film after processing;

FIG. 2b is a side cross-sectional view of the component of FIG. 2a;

FIG. 3 is a high level block diagram of one example of a system that may be used to carry out a method of the present disclosure;

FIG. 4a is a top view SEM image of a modified Pt film following angled ion beam processing using a 47.5° inclination angle of the substrate relative to the RIBE generator, which produced a period Λ=15 nm (the 10 nm Pt as-deposited material layer was generated by electron beam deposition);

FIG. 4b is a top view SEM image of a modified Pt film following angled ion beam processing using a 55° inclination angle of the substrate relative to the RIBE generator, which produced a period Λ=25 nm (the 6 nm Pt as-deposited material layer was generated by electron beam deposition);

FIG. 4c is a top view SEM image of a modified Pt film following angled ion beam processing using a 65° inclination angle of the substrate relative to the RIBE generator, which produced a period Λ=35 nm (the 6 nm Pt as-deposited material layer was generated by electron beam deposition);

FIG. 5a is a top view SEM image of a 3 nm Pt as-deposited material layer with a period Λ=10 nm;

FIG. 5b is a top view SEM image, 10 nm Pt as-deposited material layer with a period Λ=13 nm;

FIG. 6 is a top view SEM showing a large area coverage of aligned nanoscale metal lines (mean period here is about Λ=35 nm);

FIG. 7a a top view SEM image showing an as-fabricated mask structure after the RIBE operation has been performed;

FIG. 7b1 is a top view SEM image after the mask created in FIG. 7a has been replenished, and after an RIE etch operation for duration t1 has been carried out;

FIG. 7b2 is a cross-sectional side view SEM image showing the feature depth of the masks features created in FIG. 7b1;

FIG. 7c1 is a top view SEM image after an RIE etch operation for a duration t2 has been carried out;

FIG. 7c2 is a cross-sectional side view SEM image showing the depth of the features of the mask of FIG. 7c1; and

FIG. 8 is a high level flowchart illustrating one example of various operations that may be performed in carrying out a method in accordance with the present disclosure.

### DETAILED DESCRIPTION

Example embodiments will now be described more fully with reference to the accompanying drawings.

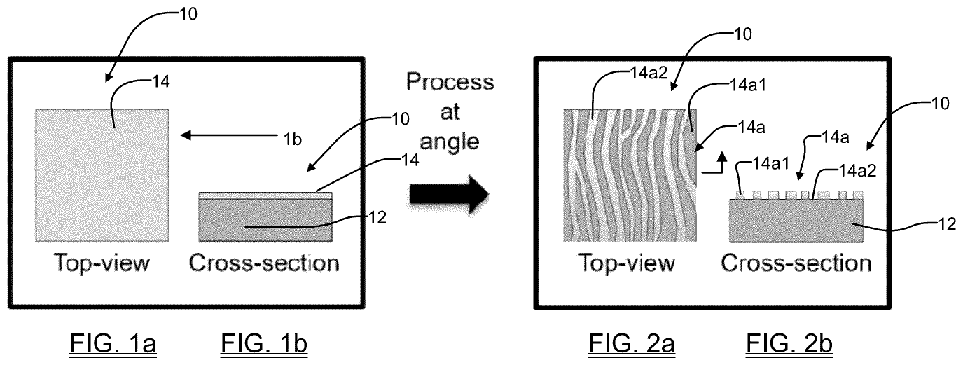

Referring to FIGS. 1a, 1b, 2a and 2b, one example of a method in accordance with the present disclosure for forming a metasurface of having nanoscale periodic metal lines on a substrate will be described. FIGS. 1a and 1b show a plan (top) view (FIG. 1a) and cross-sectional side view (FIG. 1b) of a component 10 having a substrate 12 and a material layer 14 formed thereon. In some embodiments the substrate 12 may be formed from, as an example and without limitation, glass, diamond, sapphire, silicon, silicon carbide, gallium nitride, or gallium oxide.

The material layer 14 may be formed in a plurality of different ways, and acts as a mask for subsequently performed operations. In some embodiments the material layer 14 is deposited on the substrate 12 to essentially form a film. The deposited material layer 14 in some embodiments may be a few nanometers in thickness, and in some embodiments may be up to or even thicker than tens of nanometers in thickness. The material layer 14 in some embodiments is formed using metal. In some embodiments the metal may be one of Au, Pt, or Ni, but is not limited to these particular metals.

### Angled Processing for Stimulated Metal Mask Formation

Initially, the deposited material layer 14 is inserted, at a given angle, into a charged processing beam. In some embodiments the charged processing beam is formed using a subsystem for Reactive Ion Beam Etching (RIBE). The beam generated by the RIBE subsystem has a finite beam size and divergence. In some embodiments an appropriate selection of a RIBE recipe consisting of Ar and CHF₃ is used to perform the processing of the material layer 14. The ions delivered to the material layer 14 by the RIBE beam initiates/transforms an assembly of the thin material layer 14, which again in this example is a thin metal film, into periodic nanoscale metallic features, and more specifically into a periodic grating structure 14a of parallel arranged, raised metal-containing beams 14a1 separated by spaces 14a2 where the metal material of the layer 14 has been removed. The parallel arranged, raised metal-containing beams 14a1 are believed to be created either by metal sputtering induced by the ion beam or by metal diffusion. But in either event, the orientation of substrate 12 (i.e., angle at which the substrate 12 is positioned relative) relative to the ion beam determines the period formed in the material layer 14, shown schematically in FIGS. 2a and 2b. Knowing the correlation of angle-period of the nanoscale surface created enables one to tailor the period of a nanoscale grating to be constructed by selecting the known angle that will result in the desired period.

In a subsequent manufacturing operation, the parallel-aligned metal nanoscale lines can then be transferred to the underlying substrate 12 through etching. If necessary, a mask replenishment process can be used to build up a subsequent etching mask atop the grating structure 14a to enable repeated etching of the substrate 12. In doing this, the limitations associated with etching through metal nanoparticle etching masks (that may erode quickly, and/or introduce undercutting when being etched at an angle) are overcome.

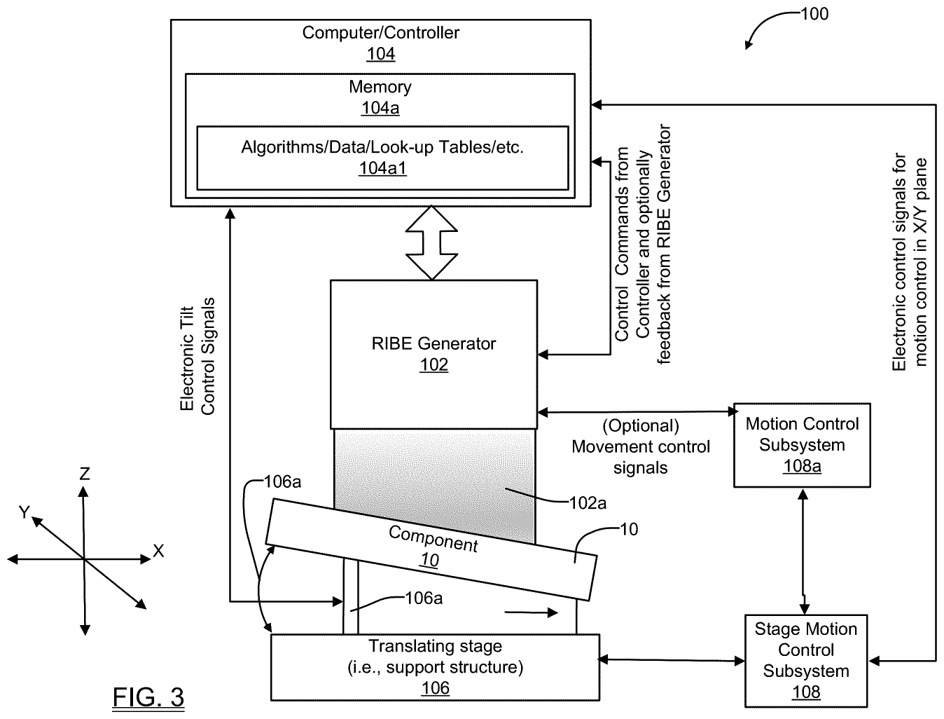

Referring to FIG. 3, a high level block diagram of one example of a system 100 for carrying out the above-described method is shown. The system 100 may include an etching beam generator 102 for generating a processing/etching beam 102a, and optionally a computer/controller 104 (hereinafter simply “controller” 104) for communicating with the RIBE generator. In some embodiments the controller 104 may include, as an example and without limitation, a memory 104a with one or more algorithms, data tables or look-up tables 104a1. If look-up table are used, the look-up tables may include previously known or previously determined information correlating specific angles of inclination of the etching beam 102a, relative to the workpiece 10, which will produce a specific period for the periodic nanoscale grating when an etching operation is completed.

In some embodiments the etching beam generator 102 may be a RIBE (Reactive Ion Beam Etching) generator. In some embodiments other types of charged beam generators may potentially be used, for example and without limitation, an electron beam generator. However, it is anticipated that for most applications a RIBE generator will be preferred. Merely for convenience, the following discussion will reference the etching beam generator 102 as being a RIBE generator.

Referring further to FIG. 3, in some embodiments a translating stage 106 is used which supports the component 10 at a desired angle of inclination 106a relative to an upper surface of the translating stage 106, and also relative to a direction of travel of the etching beam 102a. As noted above, the angle of inclination controls the period of the grating structure 14a that is created. The term “angle of inclination” may also be thought of as a relative term, since it makes no difference which one of the RIBE generator 102 or component 10 is inclined; it is the angular difference between these two components (i.e., degree of variation away from the surface of the workpiece 10 being perfectly normal to the direction of travel of the etching beam 102a that matters).

A stage motion control system 108 may be included which includes needed components (e.g., DC stepper motors, linear actuators, etc.) to move the translating stage 106 as needed within the X/Y plane. In some embodiments, for example, if the area of the substrate 12 is smaller than the area of the beam being projected by the RIBE generator 102, then no movement of the substrate 12 will be required, and the substrate may simply be supported on a stationary table or structure In some embodiments, an electronically controllable element 106a may be used to precisely adjust the tilt of the substrate 12 prior to beginning irradiation with the RIBE generator 102. In some embodiments the electronically controllable element 106a may comprise a linear actuator. In some embodiments, for example and without limitation, the electronically controllable element 106a may comprise a DC stepper motor used in connection with a linear toothed element or rack to produce linear vertical motion from rotational motion of the DC stepper motor. The speed at which the substrate is moved linearly will largely influence the period of the mask that is etched in the material layer 14. In some embodiments the controller 104 may also controllably change the angle of inclination of the substrate 12 relative to the direction of the beam 102a as the substrate is moved linearly within the X/Y plane while being supported on the translating stage 106. This enables a mask to be created by the ion beam which has a period that varies controllably (i.e., in an engineered manner) over the area of the component 10. In some embodiments the substrate 12 may be held level relative to the upper surface of the translating stage 106, while the RIBE generator 102 is positioned at the desired angle of inclination. In some embodiments the RIBE generator 102 may be held at the desired angle of inclination and moved linearly within the X/Y plane at a predetermined rate of travel while the translating stage is held stationary. Both implementations are envisioned by the present disclosure.

In some embodiments the RIBE generator 102 may be controlled by the controller 104, for example but not limited to, ON/OFF operation, beam current, beam voltage, acceleration voltage, gas flow composition and rates, etc. In some embodiments the RIBE generator 102 may include its own controller 104 and may operate fully independently of the controller 104. In some embodiments the controller 104 communicates with the stage motion control subsystem 108 and supplies motion control signals to the stage motion control subsystem.

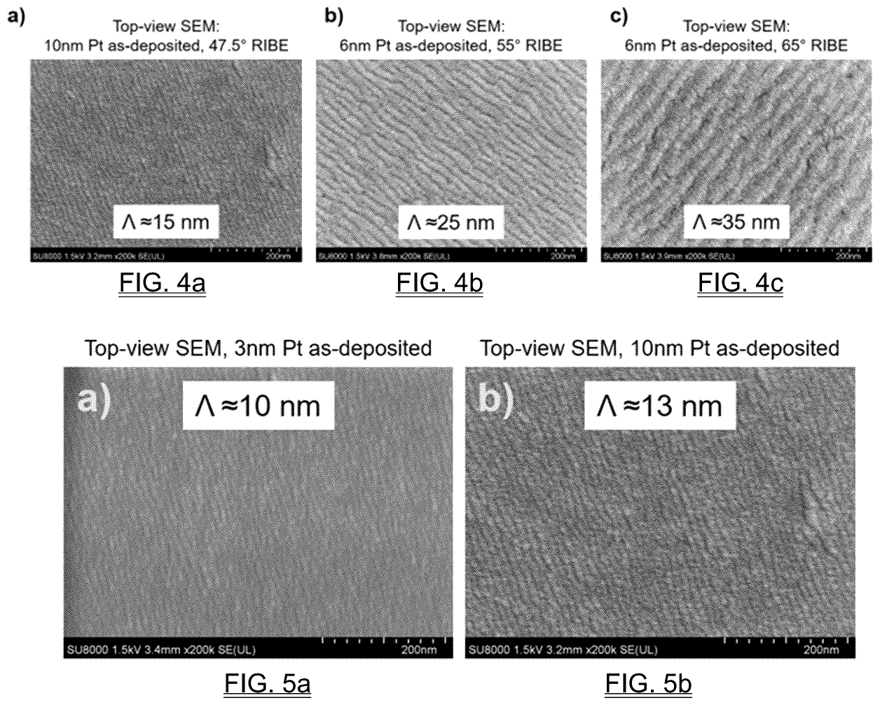

Fabricated grating-like metal masks are shown in FIGS. 4a, 4b and 4c for three samples processed with the substrate 12 orientated at three different angles as described above: a 10 nm Pt metal film, as-deposited, processed at 47.5°, shown in FIG. 4a; a 6 nm Pt film, as-deposited, processed at 55°, shown in FIG. 4b; and a 6 nm Pt film, as-deposited, processed at 65°, shown in FIG. 4c. In some embodiments, the angle between the material layer 14 surface and the direction of travel of the beam 102a is between about 20-80 degrees. In some embodiments the angle is between about 45-70 degrees. But in any case, the precise angle selected will have a direct bearing on the period of the surface structure created by the etching, and the present disclosure is not limited to any specific angle range.

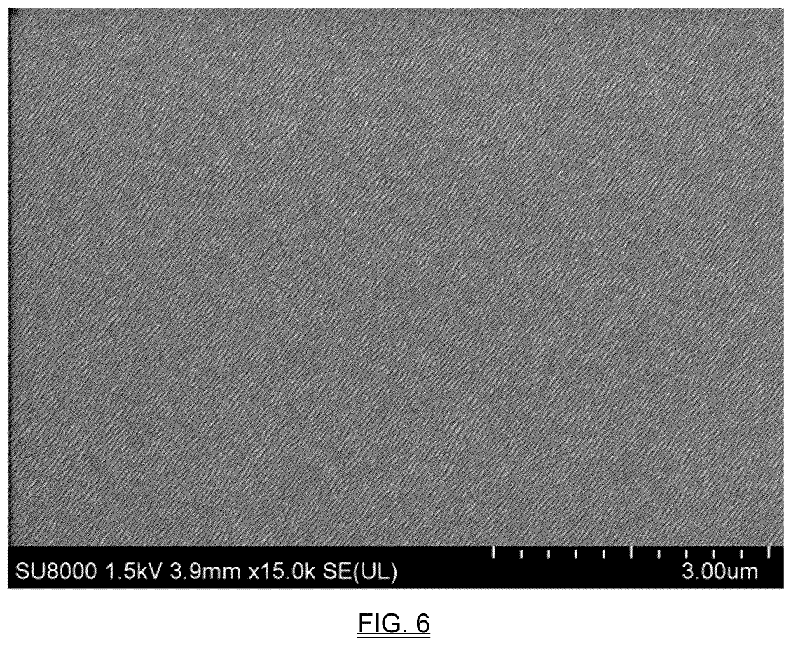

FIGS. 5a and 5b show scanning electron microscope images (top view) of a 3 nm Pt film as-deposited (FIG. 5a) and a 10 nm Pt film as-deposited, see FIG. 5b, processed at the same time. From FIGS. 5a and 5b it can be seen that the period (Λ) of the grating-like metal masks the FIGS. 5a and 5b, both processed at the same time, is nominally independent of the as-deposited metal film thickness. Put differently, the thickness of the metal-grating layer had no tangible effect on the period, Λ, of the grating that was created; the period is determined solely by the angle (e.g., angle 106a in FIG. 3) that the substrate 12 is supported at while etching with the RIBE generator 102 (FIG. 3) occurs. This approach is also scalable, as evidenced by the large area structure shown in FIG. 6; optics with area up to 1,963.5 mm² have been created using the methodology described herein.

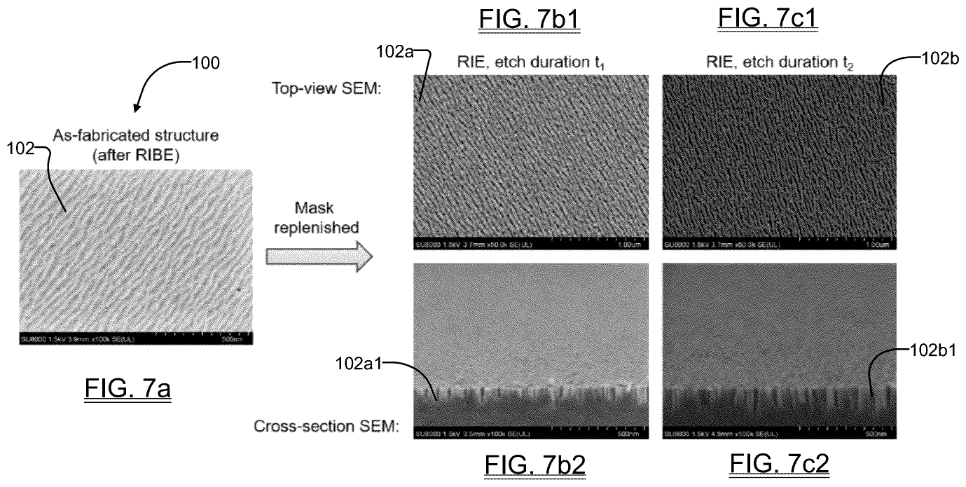

With brief reference to FIGS. 7a-7c2, a grating-like metal mask fabricated in accordance with the teachings presented above was used to create fused silica nanogratings by re-building up the metal etching mask 14a1 by a mask replenishment process. This can be accomplished by means of angled metal (e.g., Pt) deposition in accordance with the teachings of U.S. Pat. No. 11,747,639 B2 to Feigenbaum et al., issued Sep. 5, 2023 and assigned to the assignee of the present application, and hereby incorporated by reference into the present disclosure. In this example a plan (i.e., overhead) view of a nanoscale mask 102 (i.e., metal periodic grating surface) “as-fabricated” structure 100 created using RIBE processing via the RIBE generator is shown in FIG. 7a. FIG. 7b1 shows a plan view (overhead looking down) of a new fused silica grating surface 102a after one mask replenishment operation where additional metal has been deposited onto mask 102 to form the mask 102a. FIG. 7b2 shows a cross-sectional side SEM image of the etched fused silica nanograting 102a created using a reactive ion beam (RIB) for time period t1, and illustrating a height of the fused silica grating features 102a1 of the underlying substrate 102a. FIG. 7c1 illustrates a plan SEM image of a fused silica grating-like structure 102b created during a second etching operation for time duration t2. FIG. 7c2 shows a side cross-sectional SEM image of the glass features 102b1 created after completion of the time duration t₂. A significantly increased depth of the metal features 102b1 versus the glass features 102a1 can be seen in FIG. 7c2 versus FIG. 7b2. The etching used to transfer the patterns of the masks 102a and 102b into the underlying substrate was normal incidence etching (i.e., RIB normal to the mask 102a and 102b during etching operations). In these examples the etching duration t₂=2.6*t₁, and the etch depth increased by a factor of 2.6. Modification to the etch rate during the final normal incidence etch rate may be realized by adjusting the fill factor and period of the metal structure during the initial angled reactive ion beam etching operation.

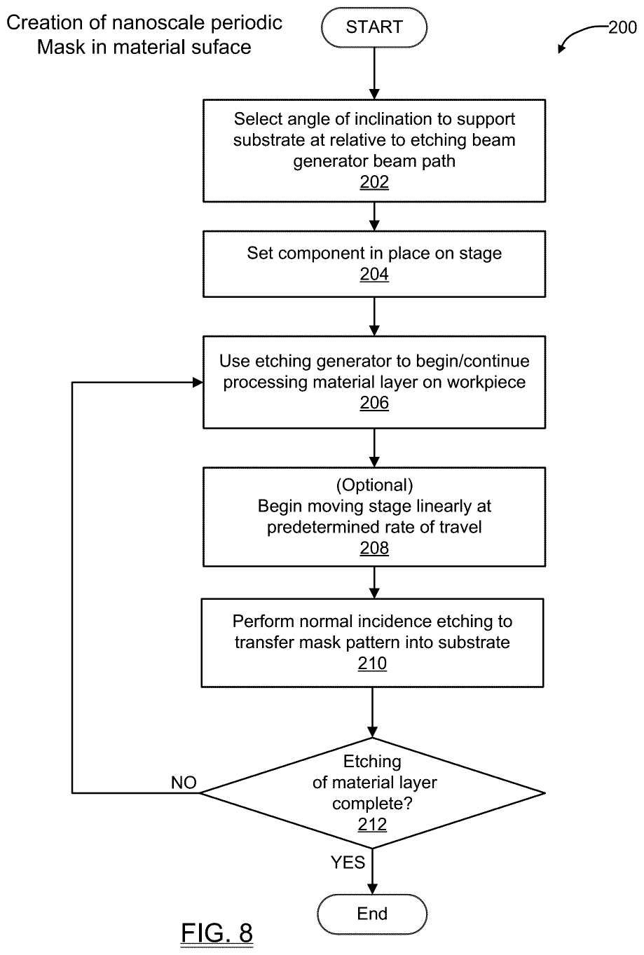

Referring briefly to FIG. 8, a flowchart 200 is shown illustrating one example of various operations that may be performed using the system 10 to create a periodic nanoscale mask. Initially at operation 202 an angle of inclination is selected to support the substrate 12 at relative to the etching beam generator beam path. The angle of incidence will have a direct bearing on the period of the nanoscale features created. At operation 204 the component may be set in place on the translating stage 106 at the desired angle (or conversely, the etching generator may be set at the desired inclination angle). At operation 206 the etching generator (e.g., RIBE generator 102) may be used to begin/continue processing the material layer (e.g., material layer 14) of the workpiece 10 to form the metal-containing beams (e.g., beams 14a1). At operation 108, if the beam from the etching generator is insufficiently large in area to cover the entire surface of the workpiece 10, then the translating stage 106 may be used to begin moving the workpiece in the X/Y plane at a predetermined rate of travel so that the beam irradiates the entire surface area of the material layer 14. Optionally, as noted above, the etching generator could be moved while the workpiece 10 is held stationary. At operation 210 normal incidence etching is performed to transfer the mask pattern into the substrate. At operation 212 a check is then made if the etching of the material layer 14 is complete (i.e., a mask is now fully formed), and if not then operations 206-210 are repeated. If the check at operation 212 produces a “YES” answer, then processing is complete.

The systems and methods of the present disclosure are expected to find utility in a wide variety of applications including, but not limited to, ultra-thin waveplate optics, as well as environmentally stable and laser damage durable metasurfaces for emphasis on short wavelength lasers. Further utility is expected in connection with large-area gratings for use with short wavelength applications (e.g., wavelengths down to soft X-ray ranges), or at conventional ultraviolet and visible wavelengths.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items. As used herein, the term “about”, when used immediately previous to a specific recited value, denotes the specific recited value as well as all values, inclusive, from +/−10% of the specific recited value.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

1. A system for creating parallel, linear features with a desired period on a surface of a workpiece, where the workpiece includes a planar substrate and a material layer formed on the planar substrate, the system comprising:
a generator configured to generate a processing beam;
a support structure for holding a workpiece, wherein an upper surface of the material layer of the workpiece is supported at an angle which is non-normal to a direction of travel of the processing beam, and wherein the angle correlates to a desired period of features to be fabricated on the upper surface of the material layer; and
the processing beam causing transformation of the material layer to create generally parallel, generally linear features having the desired a period.

2. The system of claim 1, wherein the period comprises a nanoscale period.

3. The system of claim 1, wherein the generator comprises a Reactive Ion Beam Etching (RIBE) generator.

4. The system of claim 1, wherein the material layer comprises a metal material layer.

5. The system of claim 1, further comprising a controller for controlling the generator.

6. The system of claim 1, wherein the support structure comprises a translating stage which is movable linearly.

7. The system of claim 6, further comprising a motion control subsystem for controlling motion of the translating stage within an X/Y plane.

8. The system of claim 1, wherein the angle falls within a range of about 20-80 degrees.

9. The system of claim 1, wherein the angle falls within a range of about 45-70 degrees.

10. A system for creating parallel, linear features with a desired nanoscale period on a surface of a workpiece, where the workpiece includes a planar substrate and a metal material layer formed on the planar substrate, the system comprising:
a reactive ion beam etching (RIBE) generator configured to generate a reactive ion processing beam;
a support structure for holding a workpiece, wherein one of the workpiece or the RIBE generator is tilted at a predetermined angle of inclination relative to the other to be non-parallel to the other; and
wherein the angle of inclination is selected to correlate to a desired period of generally repeating, generally parallel, line-like features etched into the upper surface of the metal material layer by the reactive ion processing beam from the RIBE generator.

11. The system of claim 10, wherein the support structure comprises a translating stage for moving the workpiece linearly within an X and Y plane.

12. The system of claim 11, further comprising a stage motion control system configured to control movement of the translating stage.

13. The system of claim 10, further comprising a controller for controlling the RIBE generator.

14. The system of claim 10, wherein the angle comprises an angle between at least one of:
20-80 degrees; or
45-75 degrees.

15. A method for forming parallel, linear features with a desired period on a surface of a workpiece, wherein the workpiece includes a substrate and a material layer on the substrate, the method comprising:
supporting the workpiece at an angle non-parallel to a direction of travel of a processing beam to be used to etch the material layer;
using the processing beam to perform a processing operation to transform the material layer to produce a periodic metasurface from the material layer;
the periodic metasurface having a plurality of generally parallel, relatively linear features produced from a remaining portion of the material layer left after the processing operation is completed; and
the angle being selected to produce a desired period for the periodic metasurface.

16. The method of claim 15, wherein supporting the workpiece at an angle comprises supporting the workpiece at an angle between 20-80 degrees.

17. The method of claim 15, further comprising moving the workpiece linearly while the processing operation is performed.

18. The method of claim 1, wherein using the processing beam comprises using a reactive ion beam to perform the processing operation.
